(19) United States
(12) Patent Application Publication
(10) Pub. No.: US 2011/0124354 A1
(43) Pub. Date: May 26, 2011

(54) MOBILE PHONE TERMINAL

(75) Inventor: Keisuke Nagata, Osaka (JP)

(73) Assignee: KYOCERA CORPORATION, Kyoto (JP)

(21) Appl. No.: 13/056,099

(22) PCT Filed: Jul. 27, 2009
(86) PCT No.: PCT/JP2009/003522

§ 371 Date: Jan. 26, 2011

(30) Foreign Application Priority Data
Jul. 30, 2008 (JP) 2008-195752

(51) Int. Cl. H04W 4/14; H04W 88/02

(52) U.S. Cl. 455/466

(57) ABSTRACT

Abstract: According to a mobile phone apparatus 10 of the present invention, when a phone number of a destination of an SMS mail is selected on the basis of an address book 42, only a name of a registrant (50a) with a phone number about which a kind of carrier (50g) is the same as a kind of carrier (40c) of this mobile phone apparatus 10 is displayed, and if the displayed name of the registrant is selected, out of the phone numbers registered as the registrant's own, only the phone number (50f) about which the kind of the carrier is the same as the kind of carrier of this mobile phone apparatus 10 is selectably displayed on a monitor (24).

### TECHNICAL FIELD

The present invention relates to a mobile phone terminal. Specifically, the present invention relates to a mobile phone terminal having a short message service function.

### DESCRIPTION OF THE RELATED ARTS

At present, a mobile phone terminal presented by each carrier that offers a mobile phone service generally has a short message service (hereinafter referred to as an “SMS (Short Massage Service)”) function. Here, the carrier means a communication business company which is classified into a type-1 electrical communication business company having a communication facility on ones own, such as a line network, and corresponds to NTT, KDDI, etc. Furthermore, the SMS is a service for sending a mail between mobile phone terminals which obtain services from the same carrier while a phone number is designated as a destination. For example, the NTT (Docomo) offers the SMS called a short mail, and the KDDI (au) offers the SMS called a C Mail. The number of characters capable of being sent and received by the SMS mail is in the order of 100 one-byte characters, and is fewer than an electronic mail (e-mail) which sends by designating a mail address. However, the SMS mail has a high utility value in that it allows the user to confirm that the communication partner receives a mail, and no communication charge is made at the side of the receiver of the mail.

A user of the mobile phone terminal registers a communication partner with whom communications are likely to be repetitively made is registered in an address book owned by the mobile phone terminal. Then, in a case that a destination of an SMS mail is designated as well, the address book is generally called to select and designate a phone number registered in the address book. As described above, an SMS mail can be sent and received only between mobile phone terminals which obtain services from the same carrier, but it takes a lot of trouble to select the communication partner to whom the user wants to send an SMS mail and the phone number thereof from the much information registered in the address book. Furthermore, it is difficult to know whether or not the mobile phone terminal of the communication partner to which the user wants to send an SMS mail obtains a service from a carrier from which the own mobile phone terminal also obtains a service, that is, whether or not an SMS mail can be sent to a desired communication partner. Thereupon, as described in Japanese Patent Application Laying-Open No. 2002-320025 ([H04M 1/275, G06F 13/00, H04M 11/00, H04Q 7/38]), a technique of only displaying a name of a registrant about which a phone number of a mobile phone terminal obtaining a service from the same carrier from which the own mobile phone terminal obtains a service is registered when an address book is called to designate a phone number as a destination of an SMS mail is invented.

In the technique described in Japanese Patent Application Laying-Open No. 2002-320025, on the basis of the phone number assigned to the mobile phone terminal, the carrier which provides a service to the mobile phone terminal is identified. Once, a phone number capable of being assigned was defined for each carrier. For example, if the phone number assigned to the mobile phone terminal is “090-1234-5678”, by the numerical values of the fourth to sixth digits from the first, that is, “123”, the carrier can be specified.

However, in Japan, a number portability (NMP) system was started from Oct. 24, 2006. The number portability system is a system in which in a case that the user changes the carrier which provides the service to the mobile phone terminal, the previous phone number can be continuously utilized in a mobile phone terminal to which a service is provided by a new carrier. Thus, in the technique described in the Japanese Patent Application Laying-Open No. 2002-320025, a problem that the carrier cannot be specified on the basis of the phone number occurs.

### DOCUMENT OF THE RELATED ARTS

### Patent Literature Document

Patent Literature Document 1: Japanese Patent Application Laying-Open No. 2002-320025

### SUMMARY OF THE INVENTION

### Problems to be Solved by the Invention

Therefore, it is a primary object of the present invention to provide a novel mobile phone terminal.

Another object of the present invention is to provide a mobile phone terminal capable of easily selecting a phone number being effective as a destination of an SMS mail on the basis of an address book.

### Means for Solving the Problems

The present invention employs following features in order to solve the above-described problems. It should be noted that reference numerals and the supplements inside the parentheses show one example of a corresponding relationship with the embodiments described later for easy understanding of the present invention, and do not limit the present invention.

A first invention is a mobile phone terminal having a short message service function, comprising: a first storage which stores an address book in which carrier information of mobile phone terminals of registrants is registered by being brought into correspondence with phone numbers of the mobile phone terminals of the registrants and identification information of the registrants; a second storage which stores a kind of carrier of an own terminal; a first displayer which displays on a monitor only the identification information of a registrant corresponding to the carrier information indicating that the kind of carrier is the same as the kind of carrier of the own terminal stored in the second storage out of the identification information of the registrants registered in the address book in response to a destination selection starting operation of a mail of a short message service; a selector which selects the identification information of the registrant in response to a selecting operation based on the display by the first displayer; and a setter which sets the phone number corresponding to the identification information of the registrant selected by the selector as a destination of the mail of the short message service.

According to the first invention, a mobile phone apparatus (10) has a short message service function. Then, a first storage (18) stores an address book in which carrier information (50g) of mobile phone terminals of registrants is registered by being brought into correspondence with phone numbers (50f) of the mobile phone terminals of the registrants and identification information (50a) of the registrants, and the second storage (18) stores the kind of carrier of the own terminal (40c). Furthermore, a first displayer (12, S7) displays on a monitor (24) only the identification information of a registrant corresponding to the carrier information indicating that the kind of carrier is the same as the kind of carrier of the own terminal stored in the second storage out of the identification information of the registrants registered in the address book in response to a destination selection starting operation of a mail of a short message service. Then, a selector (12, S21) selects the identification information of the registrant in response to a selecting operation based on the display by the first displayer, and a setter (12, S35) sets the phone number corresponding to the identification information of the registrant selected by the selector as a destination of a mail of the short message service.

Here, the kind of carrier is information indicating a specific name of a carrier, such as Docomo, au, etc. Then, the carrier information may be information indicating the name of the carrier similar to the kind of carrier, may be information capable of specifying the carrier such as an e-mail address (domain thereof), or may be information simply indicating whether the kind of carrier is the same as the kind of carrier of the own terminal, such as “◯”, “×”, etc.

According to the first invention, it is possible to easily select a phone number being effective as a destination of a mail of the short message service based on the address book.

A second invention is a mobile phone terminal having a short message service function, comprising: a first storage which stores an address book in which carrier information of mobile phone terminals of registrants is registered by being brought into correspondence with phone numbers of the mobile phone terminals of the registrants and identification information of the registrants; a second storage which stores a kind of carrier of an own terminal; a first displayer which displays on a monitor the identification information of a registrant corresponding to the carrier information indicating that the kind of carrier is the same as the kind of carrier of the own terminal stored in the second storage out of the identification information of the registrants registered in the address book such that it can be discriminated from the identification information of the other registrants in response to a destination selection starting operation of a mail of a short message service; a selector which selects the identification information of the registrant displayed so as to be discriminated from the other registrants in response to a selecting operation based on the display by the first displayer; and a setter which sets the phone number corresponding to the identification information of the registrant selected by the selector as a destination of a mail of the short message service.

According to the second invention, the mobile phone apparatus (10) has a short message service function. Then, a first storage (18) stores an address book in which carrier information (50g) of mobile phone terminals of registrants is registered by being brought into correspondence with phone numbers (50f) of the mobile phone terminals of the registrants and identification information (50a) of the registrants, and the second storage (18) stores the kind of carrier (40c) of the own terminal. Furthermore, a first displayer (12, S7) displays on the monitor (24) only the identification information of a registrant corresponding to the carrier information indicating that the kind of carrier is the same as the kind of carrier of the own terminal stored in the second storage out of the identification information of the registrants registered in the address book such that it can be discriminated from the identification information of the other registrants in response to a destination selection starting operation of a mail of a short message service. Then, a selector (12, S21) selects the identification information of the registrant displayed so as to be discriminated from the other registrants in response to a selecting operation based on the display by the first displayer, and a setter (12, S35) sets the phone number corresponding to the identification information of the registrant selected by the selector as a destination of a mail of the short message service.

Here, the kind of carrier is information indicating a specific name of a carrier, such as Docomo, au, etc. Then, the carrier information may be information indicating the name of the carrier similar to the kind of carrier, may be information capable of specifying the carrier such as an e-mail address (domain thereof), or may be information simply indicating whether the kind of carrier is the same as the kind of carrier of the own terminal, such as “◯”, “×”, etc.

According to the second invention, it is possible to easily select a phone number effective as a destination of a mail of the short message service based on the address book.

A third invention is an invention according to the first invention or the second invention, wherein the setter comprises a second displayer which displays on the monitor only the phone number corresponding to the carrier information indicating that the kind of carrier is the same as the kind of carrier of the own terminal stored in the second storage out of the phone numbers registered in the address book by being brought into correspondence with the identification information of the registrants selected by the selector, and sets the phone number corresponding to a selecting operation based on the display by the second displayer as a destination of a mail of the short service mail.

According to the third invention, a setter (12, S35) comprises a second displayer (12, S27) which displays on the monitor (24) only the phone number corresponding to the carrier information (50g) indicating that the kind of carrier is the same as the kind of carrier (40c) of the own terminal (10) stored in the second storage (18) out of the phone numbers (50f) registered in the address book (42) by being brought into correspondence with the identification information (50a) of the registrants selected by the selector (12, S21), and sets the phone number corresponding to a selecting operation based on the display by the second displayer as a destination of a mail of the short service mail.

According to the third invention, it is possible to easily select a phone number effective as a destination of a mail of the short message service based on the address book.

A fourth invention is an invention according to any one of the first to third inventions, further comprising: a disconnection detector which detects an end of a speech communication; a determiner which, when the disconnection detector detects an end of a speech communication, determines whether or not a predetermined period has elapsed since the kind of carrier registered in the address book by being brought into correspondence with the phone number in relation to the speech communication was registered in the address book, and a prompter which prompts a user to confirm the kind of carrier corresponding to the phone number in relation to the speech communication when the determiner determines that a predetermined period has elapsed.

According to the fourth invention, a disconnection detector (12, S49) detects an end of a speech communication. Then, a determiner (12, S55), when the disconnection detector detects an end of a speech communication, determines whether or not a predetermined period (50i) has elapsed since the kind of carrier (50g) registered in the address book (42) by being brought into correspondence with the phone number (50f) in relation to the speech communication was registered in the address book (50h), and a prompter (12, S57) prompts a user to confirm the kind of carrier corresponding to the phone number in relation to the speech communication when the determiner determines that a predetermined period has elapsed.

According to the fourth invention, it is possible to prompt the user of the mobile phone apparatus to periodically confirm the kind of carrier of the phone number registered in the address book.

A fifth invention is an invention according to any one of the first to fourth inventions, further comprising a register which registers the carrier information of the mobile phone terminal of the registrant by bringing it into correspondence with the phone number of the mobile phone terminal of the registrant and the identification information of the registrant in the address book in response to a registering operation.

According to the fifth invention, a register (12) registers the carrier information (50g) of the mobile phone terminal of the registrant by bringing it into correspondence with the phone number (50f) of the mobile phone terminal of the registrant and the identification information (50a) of the registrant in the address book (42) in response to a registering operation.

According to the fifth invention, the user can register the carrier information of the mobile phone terminal of the registrant by bringing it into correspondence with the phone number of the mobile phone terminal of the registrant and the identification information of the registrant in the address book.

A sixth invention is an invention according to the fifth invention, wherein the register registers the carrier information based on the kind of carrier determined on the basis of a domain of the e-mail address of the registrant registered in the address book.

In the sixth invention, the register (12) registers the carrier information (50g) based on the kind of carrier determined on the basis of a domain of the e-mail address (50q) of the registrant registered in the address book (42).

According to the sixth invention, the kind of carrier of the carrier information to be registered is determined on the basis of the domain of the e-mail address, capable of saving the labor by the user.

A seventh invention is an invention according to the fifth invention, wherein the register registers the carrier information based on the kind of carrier determined on the basis of a signal received when a phone call is made with a telephone apparatus of the communication partner.

In the seventh invention, the register (12) registers the carrier information (50g) based on the kind of carrier determined on the basis of a signal received when a phone call is made with a telephone apparatus of the communication partner.

According to the seventh invention, the kind of carrier of the carrier information to be registered is determined on the basis of the signal received when a phone call is made with the communication partner, capable of saving the labor by the user.

The above described objects and other objects, features, aspects and advantages of the present invention will become more apparent from the following detailed description of the present invention when taken in conjunction with the accompanying drawings.

### ADVANTAGE OF THE INVENTION

According to the present invention, it is possible to easily select an effective phone number as a destination for a mail of the short message service on the basis of an address book

### BRIEF DESCRIPTION OF THE DRAWINGS

FIG. 1 is a block diagram showing a mobile phone apparatus 10 as one embodiment of a first invention.

FIG. 2 is a front view showing a diagram of the mobile phone apparatus 10 as one embodiment of the first invention.

FIG. 3 is an illustrative view showing one example of profile information.

FIG. 4 is an illustrative view showing one example of a display of the profile information.

FIG. 5 is an illustrative view showing one example of a list of persons registered in an address book.

FIG. 6 is an illustrative view showing one example of an address book file indicating information on the person registered in the address book.

FIG. 7 is an illustrative view showing one example of a display of the address book file.

FIG. 8 is an illustrative view showing one example of a display of an LCD monitor when a destination of an SMS mail is designated.

FIG. 9 is an illustrative view showing one example of a display of the LCD monitor when the destination of an SMS mail is designated.

FIG. 10 is an illustrative view showing one example of a display of the LCD monitor when the destination of the SMS mail is designated.

FIG. 11 is an illustrative view showing one example of a display of the LCD monitor when the destination of the SMS mail is designated.

FIG. 12 is an illustrative view showing one example of a display of the LCD monitor when the destination of the SMS mail is designated.

FIG. 13 is an illustrative view showing one example of a display of the LCD monitor when the destination of the SMS mail is designated.

FIG. 14 is a flowchart describing processing of a routine to be executed by a processor when contents of the address book are displayed to select a phone number of a destination of the SMS mail.

FIG. 15 is a flowchart sequel to the flowchart of FIG. 14.

FIG. 16 is an illustrative view describing an answer tone sent back from a base station of a carrier of a mobile phone apparatus of a communication partner.

FIG. 17 is an illustrative view showing one example of a display of the LCD monitor when the kind of carrier is set.

FIG. 18 is an illustrative view showing one example of a display of the LCD monitor when the kind of carrier is set.

FIG. 19 is an illustrative view showing one example of a display of the LCD monitor when the kind of carrier is set.

FIG. 20 is an illustrative view showing one example of a display of the LCD monitor when the kind of carrier is set.

FIG. 21 is an illustrative view showing one example of a display of the LCD monitor when the kind of carrier is set.

FIG. 22 is a flowchart describing processing of a routine to be executed by the processor in a case that the confirmation of the kind of carrier is prompted to the user at the end of a speech communication.

FIG. 23 is an illustrative view showing one example of the display of the LCD monitor when the kind of carrier is set on the basis of a domain of an e-mail address.

FIG. 24 is an illustrative view showing one example of the display of the LCD monitor when the kind of carrier is set on the basis of the domain of the e-mail address.

FIG. 25 is an illustrative view showing one example of a domain table.

FIG. 26 is an illustrative view showing one example of the display of the LCD monitor when the kind of carrier is set on the basis of the domain of the e-mail address.

FIG. 27 is an illustrative view showing one example of the LCD monitor when a destination of an SMS mail is designated.

### FORMS FOR EMBODYING THE INVENTION

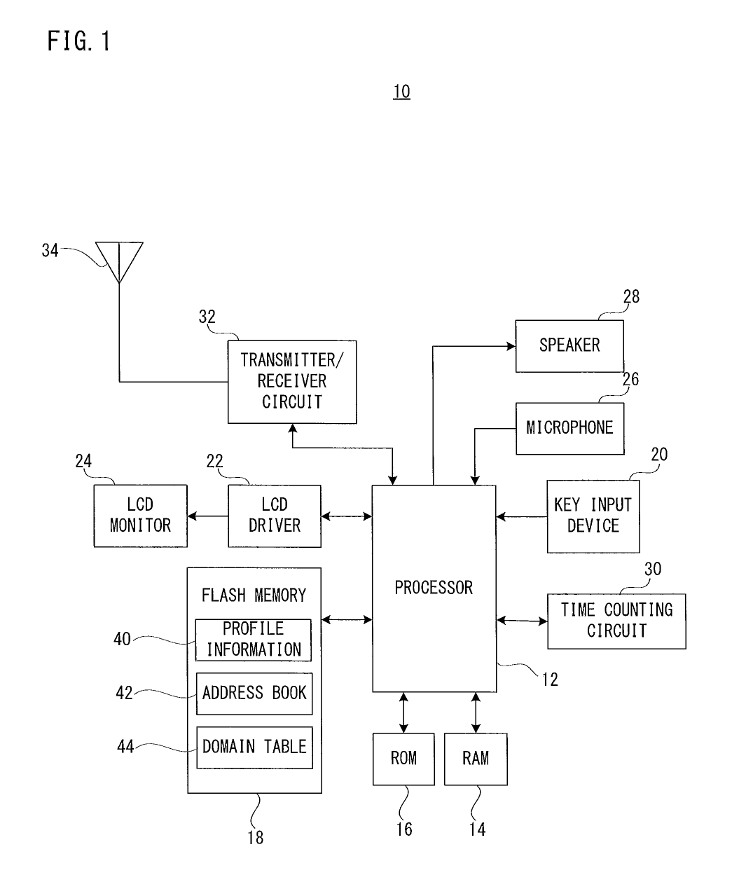

Referring to FIG. 1, a mobile phone apparatus 10 as a mobile phone terminal includes a processor 12. As understood from FIG. 1, a processor 12 is connected with a RAM (Random Access Memory) 14, a ROM (Read Only Memory) 16, a flash memory 18, a key input device 20, an LCD (Liquid Crystal Display) driver 22, a microphone 26, a speaker 28, a time counting circuit 30 and a transmitter/receiver circuit 32.

The RAM 14 is a storing device capable of being accessed from the processor 12, and utilized as a temporary storage at a time of information arithmetic processing by the processor 12.

The ROM 16 is an EEPAROM (Electrically Erasable and Programmable Read Only Memory) which is electrically rewritable, for example, and stores various programs to be executed by the processor 12 and various data to be utilized in these programs.

The flash memory 18, which is also called a flash ROM, is a nonvolatile storing device from and to which data can be freely read and written, and is a SIM (International Mobile Subscriber Identity) card detachable to the mobile phone apparatus 10, for example. In the flash memory 18, profile information 40 being information on an owner of the mobile phone apparatus 10, an address book 42, and a domain table 44 are stored.

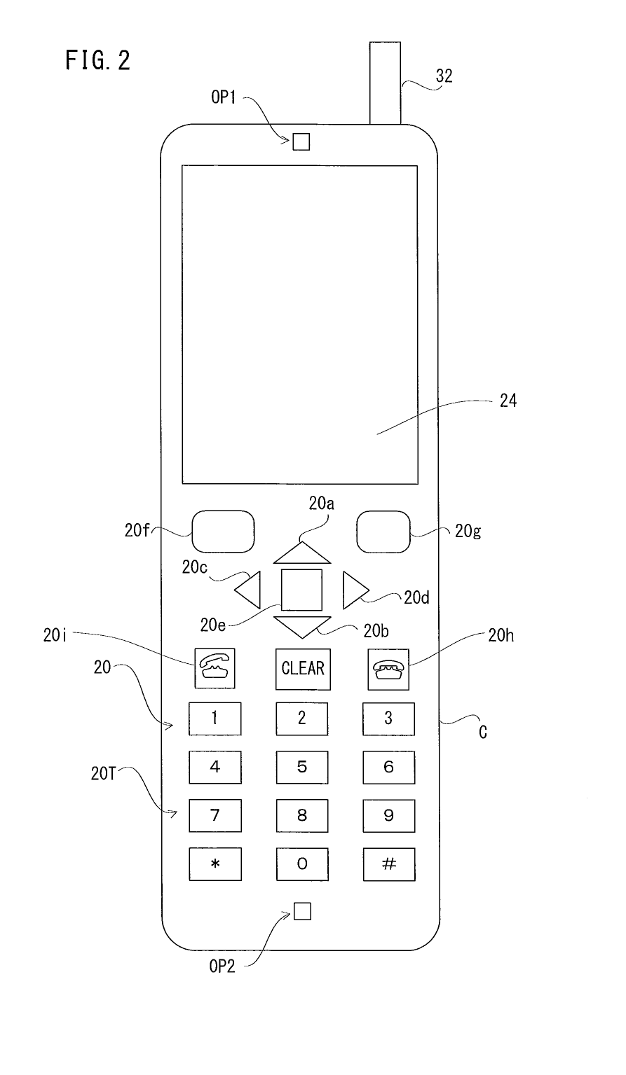

The key input device 20 has a plurality of keys including a numeric keypad 20T (see FIG. 2), and is to give an instruction to the processor 12 and input a value in response to a push of each of the keys by the user.

The LCD driver 22 controls an LCD monitor 24 connected to the LCD driver 22 to display characters and images on the LCD monitor 24 according to an instruction from the processor 12.

The microphone 26 captures a sound issued by the user to convert it into an electric signal, and outputs the electric signal to the processor 12. Furthermore, the speaker 28 converts an electric signal applied from the processor 12 into a sound and outputs the same.

The time counting circuit 30 is a circuit for counting a time, and sends back information on current year, month and day in response to a request from the processor 12.

The transmitter/receiver circuit 32 is a circuit for implementing wireless communications in a CDMA (Code Division Multiple Access) system, for example. When a calling operation is performed on the key input device 20, the processor 12 controls the transmitter/receiver circuit 32 to output a calling signal. The calling signal output from the transmitter/receiver circuit 32 is output from an antenna 34 to be transmitted to a telephone apparatus of a communication partner via a mobile communication network including base stations. When a called operation is performed on the telephone apparatus of the communication partner, a speech communication allowable state is established.

When a speech communication end operation is performed on the key input device 20 after the transition to the communication allowable state, the processor 12 controls the transmitter/receiver circuit 32 to transmit a speech communication end signal to the telephone apparatus of the communication partner. After transmission of the speech communication end signal, the processor 12 ends the speech communication processing. In a case that a speech communication end signal is received first from the communication partner as well, the processor 12 ends the speech communication processing. Furthermore, in a case that a speech communication end signal is received not from the communication partner but from the mobile communication network as well, the processor 12 ends the speech communication processing.

When a calling signal from the telephone apparatus of the communication partner is received by the antenna 34, the transmitter/receiver circuit 32 notifies the processor 12 of an incoming call. The processor 12 outputs calling source information described in the incoming call notification to the LCD monitor 24 and outputs an incoming call tone from an incoming call notifying speaker not shown. When a called operation is performed on the key input device 20, a communication allowable state is established.

In the communication allowable state, following processing is executed. A modulated audio signal (high frequency signal) transmitted from the telephone apparatus of the communication partner is received by the antenna 34. The received modulated audio signal undergoes demodulation processing and decode processing by the transmitter/receiver circuit 32. The received voice signal acquired by such processing is output from the speaker 28. A voice signal to be transmitted captured by the microphone 26 undergoes encoding processing and modulation processing by the transmitter/receiver circuit 32. The modulated audio signal acquired by such processing is transmitted to the telephone apparatus of the communication partner via the antenna 34 as described above.

FIG. 2 is an external view showing the mobile phone apparatus 10. Referring to FIG. 2, the mobile phone apparatus 10 has a case C formed in a tabular shape. On a side surface in a longitudinal direction of the case C, the antenna 34 for wireless communication is placed. On a lower part of the top surface of the case C, the key input device 20 is placed. The key input device 20 includes a numeric keypad 20T, an up key 20a, a down key 20b, a left direction key 20c, a right direction key 20d, a center key (function key) 20e, an SMS mail key (function key) 20f, an address book key (function key) 20g, a power source/speech communication end key 22h and a calling key 22i, each key being a push switch. Furthermore, on an upper part of the top surface of the case C, the LCD monitor 24 is placed. An operation of pushing each key by the user is called a “key input” hereafter. It should be noted that the center key 20e, the SMS mail key 20f, and the address book key 20g work as function keys.

In addition, near the upper end of the top surface of the case C, an opening OP1 leading to the speaker 28 not shown in FIG. 2 is provided, and near the lower end of the top surface of the case C, an opening OP2 leading to the speaker 26 not shown in FIG. 2 is similarly provided. Accordingly, the user can hear a sound output from the speaker 28 through the opening OP1 and input own voice to the microphone 26 through the opening OP2.

Such a mobile phone apparatus 10 has an SMS (Short Message Service) function, and can send a mail to another mobile phone apparatus which obtains a service from a carrier from which the mobile phone apparatus 10 obtains a service, by utilizing the SMS function. The mail which is sent and received by the SMS function is called an “SMS mail”. The SMS mail is sent while the phone number of the mobile phone apparatus of the communication partner is designated as a destination. The contents of communication technologies such as a communication protocol of SMS mails, etc. have been well known, and therefore, an explanation in detail is omitted.

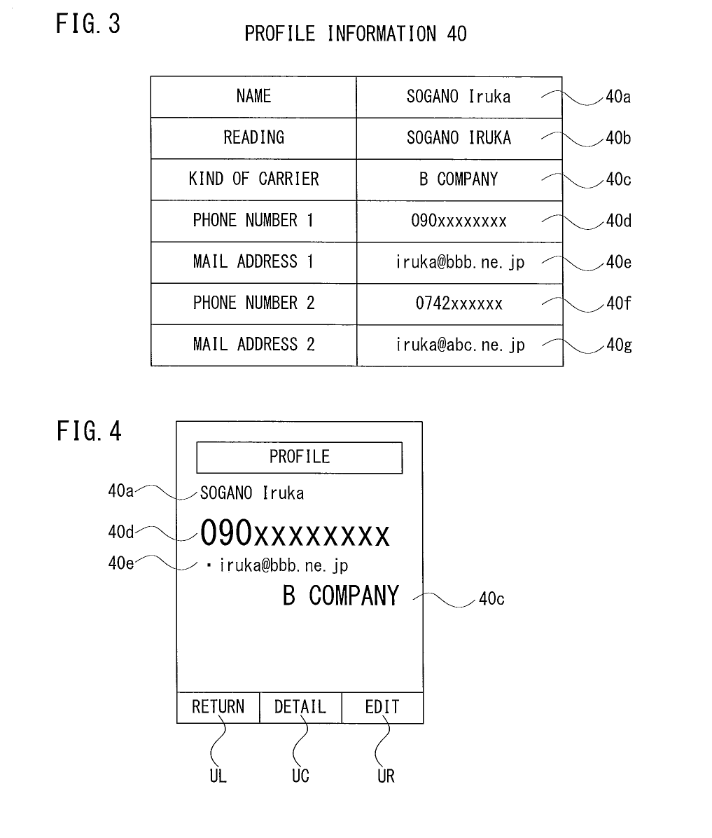

In the flash memory 20, profile information 40 as shown in FIG. 3 is stored. The profile information 40 is information on an owner of the mobile phone apparatus 10, and information on items, such as a name 40a, a reading 40b, a kind of carrier 40c, a phone number (1) 40d, a mail address (1) 40e, a phone number (2) 40f, a mail address (2) 40g, etc. as shown in FIG. 3. Here, in each item of the profile information 40, information of each of them is stored in text format, for example.

The profile information 40 is displayed as a profile screen as shown in FIG. 4 when a key input is performed on the center key 20e in a state that a standby screen (not illustrated) is displayed on the LCD monitor 24 to display a menu, and a key input is further performed on the “0 (zero)” key included in the numeric keypad 20T. As shown in FIG. 4, in the profile screen, only the name 40a for making identifiable from other communication partners, the kind of carrier 40c for discriminating the carrier, the phone number (1), and the mail address (1) are displayed out of the profile information 40 in FIG. 3. The carrier stored as a part of the profile information 40 in the flash memory 20 and indicated by the kind of carrier 40c displayed on the profile screen shown in FIG. 4 is a carrier that offers a service to this mobile phone apparatus 10. In the form of this embodiment, the carrier of the mobile phone apparatus 10 shall be a B company. Accordingly, in the mobile phone apparatus 10, it is possible to send and receive SMS mails with other mobile phone apparatuses that obtain services from the B company, by utilizing the SMS function.

At a center portion of a bottom field UC of the lower part of the profile screen shown in FIG. 4, “detail” is displayed, at a left portion of the bottom field, “return” is displayed, and at a right portion of the bottom field UR, “edit” is displayed. The center portion of the bottom field UC corresponds to the function key (center key) 20e, and a key input is performed on the function key 20e to thereby provide an instruction of “detail” displayed at the center portion of the bottom field UC to the processor 12. Similarly, the left portion of the bottom field UL corresponds to the function key (SMS mail key) 20f, and the right portion of the bottom field UR corresponds to the function key (address book key) 20g. A key input is performed on the function key 20f to thereby provide an instruction of “return” to the processor 12, and a key input is performed on the function key 20g to thereby provide an instruction of “edit” to the processor 12. The correspondences between these function keys 20e, 20f and 20g and the center portion of the bottom field UC, the left portion of the bottom field UL, and the right portion of the bottom field UR are true for the displays of the LCD monitor 24 described later.

When a key input is performed on the function key 20e to thereby designate the “detail”, all information of the profile information 40 can be displayed. Furthermore, when a key input is performed on the function key 20g to designate the “edit”, each information of the profile information 40 can be edited. It should be noted that out of the information of the profile information 40, the information of the kind of carrier 40c, the phone number (1) 40d, and the mail address (1) 40e are information assigned to the mobile phone apparatus 10, and cannot be edited by designating the “edit” at the right portion of the bottom field UR of the profile screen. Here, when a key input is performed on the function key 20f to designate the “return”, a return to the standby screen is made.

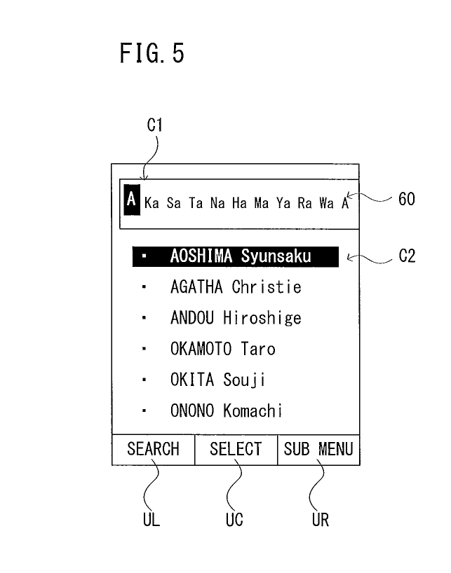

In addition, as described above, in the flash memory 18, the address book 42 is stored, and a key input is performed on the address book key (function key) 20g in a state that the standby screen is displayed on the LCD monitor 24 to thereby call the data in the address book 42 and display the contents on the LCD monitor 24 as shown in FIG. 5. On the screen displaying the address book 42 shown in FIG. 5, a displayed line selecting field 60 is displayed at the upper portion. A key input is performed on the left direction key 20c or the right direction key 20d to thereby move a cursor C1 (a position where a character display is inverted. This holds true hereunder.) displayed in the displayed line selecting field 60 to thereby select any one of [symbol] [symbol] (Japanese Hiragana (A, Ka, Sa, Ta, Na, Ha, Ma, Ya, Ra, Wa) and A (alphabet)” displayed in the displayed line selecting field 60. Then, a name about which the initial character of reading belongs to any one (A column of Japanese Kana syllabary, for example) of the columns [symbol] [symbol] (Japanese Hiragana (A, Ka, Sa, Ta, Na, Ha, Ma, Ya, Ra, Wa) and A (alphabet)” selected by the cursor C1 is displayed. The example in FIG. 5 shows an initial state when the address book 42 is called, and names such as individuals, etc. about which the initial character of the reading (Japanese Katakana) belongs to the “A column of Japanese Kana syllabary” are displayed.

The address book 42 has a configuration of the “vCard” that conforms to the global standard of the electronic business card defined by the IMC (Internet Mail Consortium), for example, and stores one record (one person) of data as a vcf file. The vcf file is called an “address book file 50”.

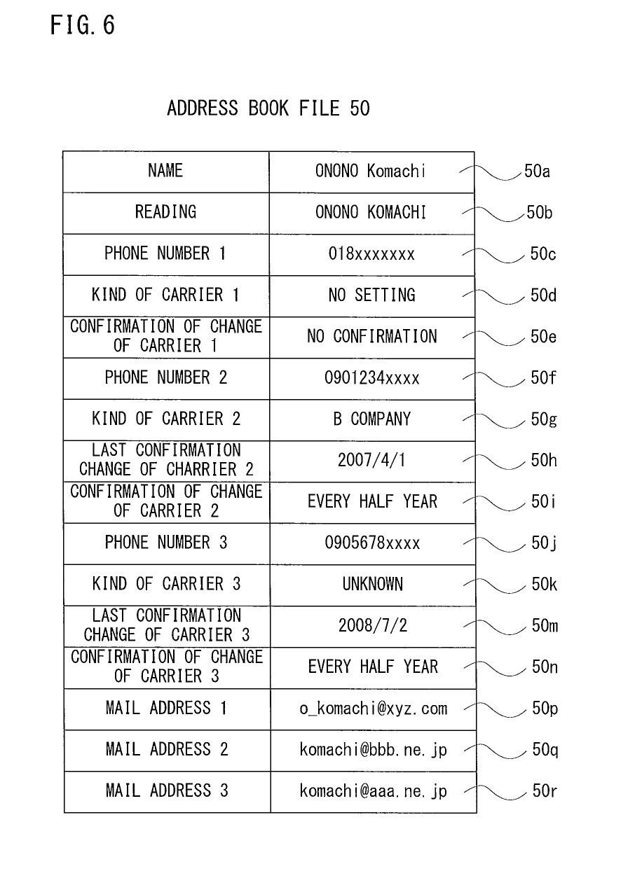

In the address book file 50, items as shown in FIG. 6 are stored, for example. That is, in the address book file 50, items of a name 50a, a reading 50b, a phone number (1) 50c, a kind of carrier (1) 50d, a confirmation of the change of the carrier (1) 50e, a phone number (2) 50f, a kind of carrier (2) 50g, a last confirmation of the change of the carrier (2) 50h, a confirmation of the change of the carrier (2) 50i, a phone number (3) 50j, a kind of carrier (3) 50k, a last confirmation of the change of the carrier (3) 50m, a confirmation of the change of the carrier (3) 50n, a mail address (1), a mail address (2), and a mail address (3) are stored. Here, the phone number (1) 50c, the kind of carrier (1) 50d and the confirmation of the change of the carrier (1) 50e, the phone number (2) 50f, the kind of carrier (2) 50g, the last confirmation of the change of the carrier (2) 50h and the confirmation of the change of the carrier (2) 50i, and the phone number (3) 50j, the kind of carrier (3) 50k, the last confirmation of the change of the carrier (3) 50m and the confirmation of the change of the carrier (3) 50n are connected with each other and stored by being brought into correspondence with each other. Here, the information stored in the item of the name 50a is identification information of a registrant. Furthermore, in each item of the address book file 50, information is each stored as text information, for example.

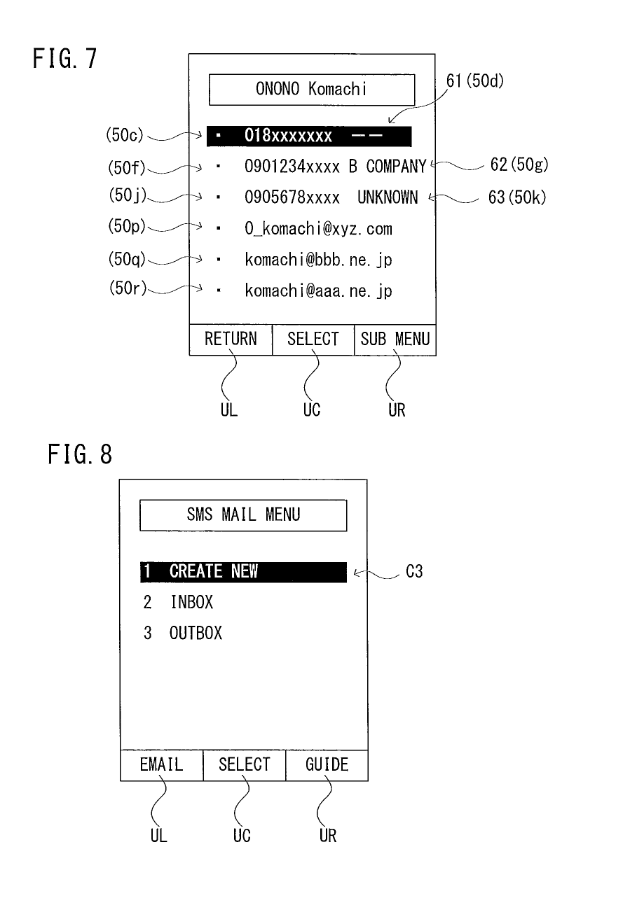

When a key input is performed on the down key 20b to move a cursor C2 to [symbol] (Japanese Kanji (ONONO Komachi)), for example, in the displayed state of the address book 42 shown in FIG. 5, and a key input is performed on the function key (center key) 20e to designate the “select” at the center portion of the bottom field UC, registered contents as to [symbol] (Japanese Kanji (ONONO Komachi)) are displayed as shown in FIG. 7 on the LCD monitor 24 on the basis of the address book file 50 shown in FIG. 6.

As can be understood from FIG. 7, contents of the items, such as the phone number (1) 50c, the phone number (2) 50f, the phone number (3) 50j, the mail address (1) 50p, the mail address (2) 50q, and the mail address (3) 50r stored in the address book file 50 are displayed on the LCD monitor 24. Furthermore, “0901234xxxx” displayed on the basis of the phone number (2) 50f is a phone number of the mobile phone apparatus as can be judged from the initial “090”. Then, in a following portion of the display of the phone number 62, that the kind of the carrier which offers a service to the mobile phone apparatus to which the phone number is assigned is the “B company” is displayed on the basis of the information (carrier information) stored in the item of the kind of carrier (2) 50g. On the other hand, in a following portion of the number display 63 of “0905678xxxx” displayed on the basis of the item of the phone number (3) 50j, “unknown” is displayed as a kind of carrier on the basis of the item of the kind of carrier (3) 50k. Here, “018xxxxxxx” displayed on the basis of the phone number (1) 50c is a phone number of the land-line phone, and in a following portion of the phone number display 61, “- - ” is displayed on the basis of the registered content of “no setting” of the item of the kind of carrier (1) 50d.

As described above, the carrier which offers a service to this mobile phone apparatus 10 is the B company, and therefore, from this mobile phone apparatus 10, an SMS mail can be sent regarding the “0901234xxxx” about which the carrier is similarly the B company as shown in FIG. 7 as a destination. Here, a registering method of the kind of carriers (1) 50d, (2) 50g, (3) 50k to the address book 42 is described later.

When a key input is performed on the SMS mail key 20f in a state that the standby screen is displayed on the LCD monitor 24 of the mobile phone apparatus 10, an SMS mail menu as shown in FIG. 8 is displayed on the LCD monitor 24. When a key input is performed on the function key 20e to designate the “select” at the center portion of the bottom field UC in a state that a cursor C3 is placed at the “create new”, creating a new SMS mail can be started. Here, when the “select” is designated in a state that the cursor C3 is placed at an “inbox”, a list of the SMS mails which have ever been received can be displayed, and when the “select” is designated in a state that the cursor C3 is placed at an “outbox”, a list of the SMS mails which have ever been sent can be displayed.

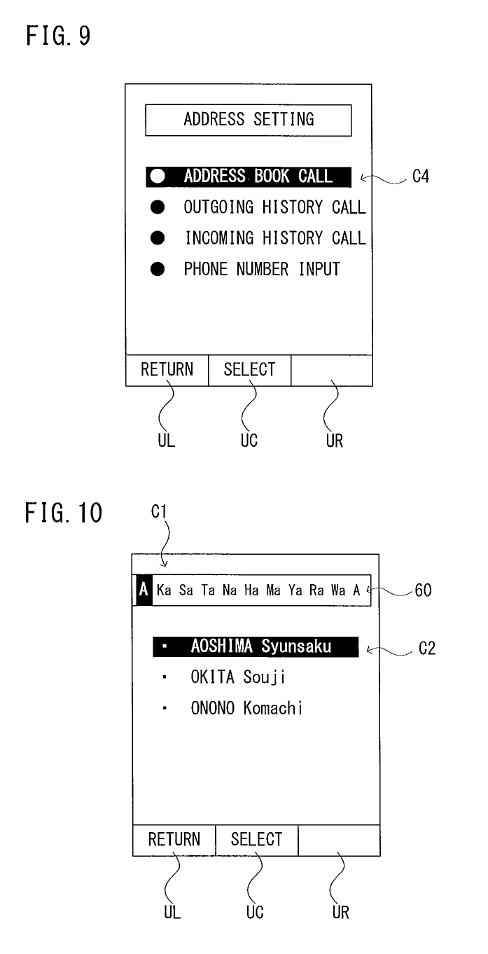

When the “create new” is designated by the “select”, a screen for selecting a setting method of a destination of an SMS mail as shown in FIG. 9 is displayed on the LCD monitor 24. When a key input is performed on the function key 20e to designate the “select” at the center portion of the bottom field UC in a state that a cursor C4 is placed at the “address book call” on the screen shown in FIG. 9, the address book 42 is called to thereby select the phone number registered in the address book 42 and designate it as a destination of the SMS mail.

Furthermore, when the “select” is designated in a state that the cursor C4 is placed at an “outgoing history call”, selection is made from a list of the phone numbers of the destinations to which the SMS mails have already been sent to thereby regard the selected one as a destination of an SMS mail, and when the “select” is designated in a state that the cursor C4 is placed at an “incoming history call”, a selection is made from a list of phone numbers of the mail sources of the SMS mails which has ever been received to thereby regard the selected one as a destination of an SMS mail. In addition, when the “select” is designated in a state that the cursor C4 is placed at the “phone number input, the user operates each of the keys of the numeric keypad 20T to thereby directly input the phone number of the destination.

When “select” of the “address book call” is designated, registered contents of the address book 42 are displayed on the LCD monitor 24 as shown in FIG. 10. In FIG. 10, as understood from the fact that the cursor C1 of the displayed line selecting field 60 is placed in the position of the “A column of Japanese Kana syllabary”, a name of an individual, etc. whose reading registered in the address book 42 starts from the “A column of Japanese Kana syllabary” (50a (see FIG. 6)) is displayed. Here, out of the names of the individuals whose readings start from the “A column of Japanese Kana syllabary”, in each of the address book files 50 of the individuals, only the name of the individual having the mobile phone number (2) 50f about which the “B company” as a kind of carrier registered in the kind of carrier (2) 50g as shown in FIG. 6 the same as the kind of carrier 40c (see FIG. 3) of the mobile phone apparatus 10 is registered is displayed. That is, in each of the address book files 50 of [symbol] (Japanese Kanji (AOSHIMA Syunsaku)), [symbol] (Japanese Kanji (OKITA Souji)), and [symbol] (Japanese Kanji (ONONO Komachi)) displayed in FIG. 10, the item storing the phone number that is brought into correspondence with the item storing the kind of carrier indicating the “B company” is registered. Conversely, with reference to the aforementioned FIG. 5, in each of the address book files 50 of “Agatha Christie”, [symbol] (Japanese Kanji (ANDOU Hiroshige)), and [symbol] (Japanese Kanji OKAMOTO Taro)) which are not displayed in FIG. 10, the item storing the phone number that is brought into correspondence with the item storing the kind of carrier indicating the “B company” is not registered.

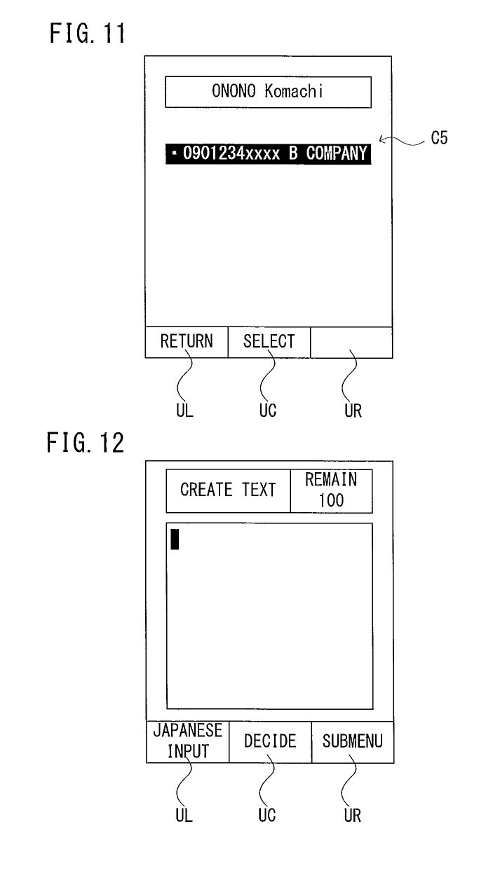

In addition, while the LCD monitor 24 is displayed as shown in FIG. 10, when a key input is performed on the down key 20b in a state that the cursor C2 is placed at the [symbol] (Japanese Kanji (ONONO Komachi)), and a key input is performed on the function key 20e to designate the “select” at the center portion of the bottom field UC, the phone number registered in the address book file 50 of [symbol] [symbol] (Japanese Kanji (ONONO Komachi)) in FIG. 6 is displayed as shown in FIG. 11. Here, as understood from FIG. 6 and FIG. 11, only the phone number stored in the item that is brought into correspondence with the item storing the kind of carrier indicating the “B company”, that is, only the “0901234xxxx” stored in the item of the phone number (2) 50f that is brought into correspondence with the item of the kind of carrier (2) 50g is displayed. Here, in a case that there are a plurality of items each storing the phone number that is brought into correspondence with the item storing the kind of carrier indicating the “B company” in the address book file 50, a plurality of phone numbers are displayed on the screen in FIG. 11. While the LCD monitor 24 is displayed as shown in FIG. 11, when that a key input is performed on the function key 20e to designate the “select” at the center portion of the bottom field UC in a state that a cursor C5 is placed at a target phone number, the phone number at which the cursor C5 is placed is selected (set) as a destination of an SMS mail.

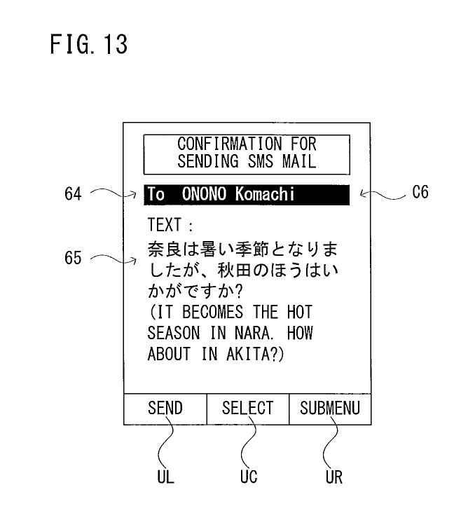

When the destination of the SMS mail is thus selected, a screen for creating a text of the SMS mail as shown in FIG. 12 is displayed on the LCD monitor 24. The user performs a key input of each key of the numeric keypad 20T on the screen to create a text, and a key input is performed on the function key 20e to designate the “decide” at the center portion of the bottom field UC, creating the text is ended, and a confirmation screen as shown in FIG. 13 is displayed. On the confirmation screen shown in FIG. 13, a name of the destination of the SMS mail 64 and a mail text 65 are displayed.

When a key input is performed on the function key 20e to designate the “select” at the center portion of the bottom field UC in a state that the LCD monitor 24 is displayed as shown in FIG. 13, that is, in a state that the cursor C6 is placed at the name of the destination 64, the display of the LCD monitor 24 returns to the state shown in FIG. 11. Thereafter, cancelation is made to display the selection screen in FIG. 9 in which selection of the phone number of the destination can performed. Furthermore, when a key input is performed on the function key 20e in a display shown in FIG. 13 to designate the “select” at the center portion of the bottom field UC in a state that a key input is performed on the down key 20b to place the cursor C6 at the mail text 65, the display of the LCD monitor 24 returns to the state shown in FIG. 12 (here, a state that the text has been input) that allows for edition to the text.

Then, when a key input is performed on the function key 20f to designate the “send” at the left portion of the bottom field UL in a state that the display of the LCD monitor 24 is as shown in FIG. 13, an SMS mail including the mail text 65 as a content is sent to the individual of the name of the destination 64, that is, the mobile phone apparatus to which the phone number selected in FIG. 11 is assigned. In this example, the destination is first selected, and the mail text is then input, but after an input of the mail text, the destination may be selected.

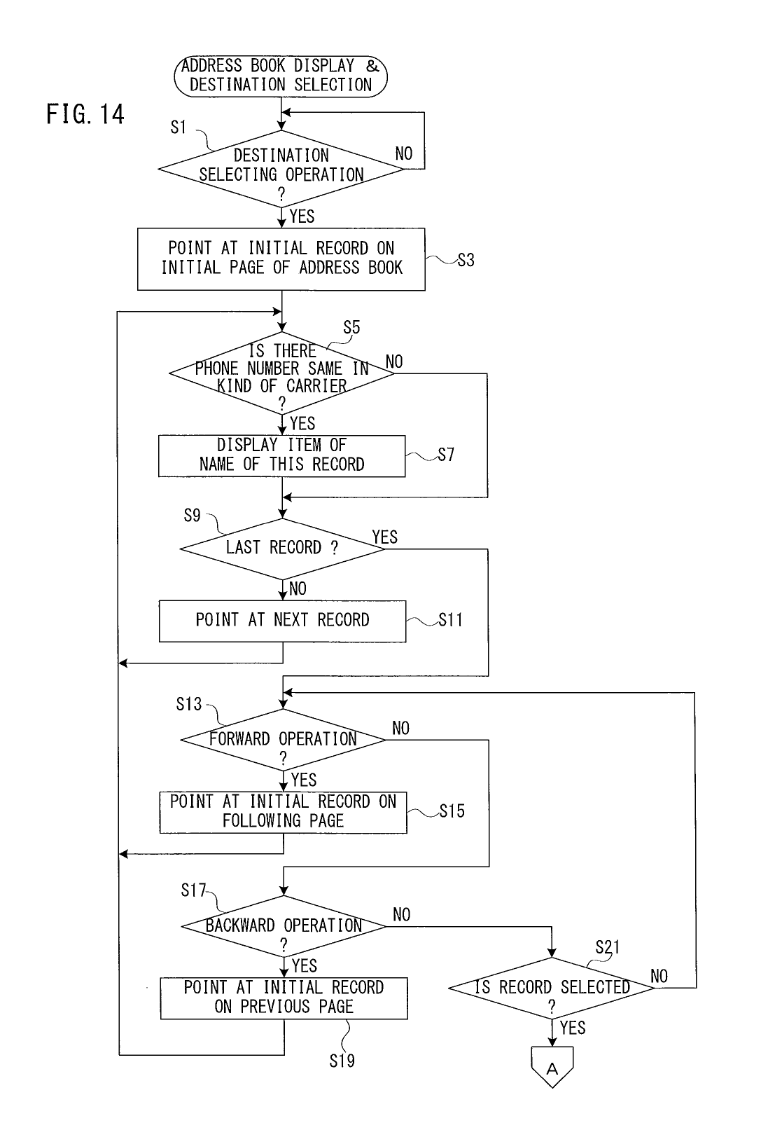

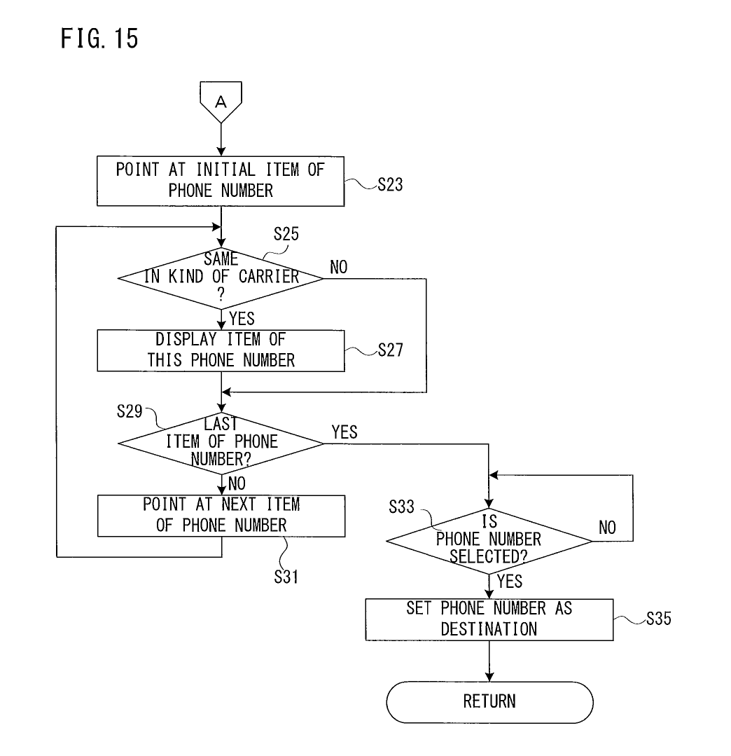

As described above, processing of a routine to be executed by the processor 12 of the mobile phone apparatus 10 when the contents of the address book 42 is displayed and a phone number of a destination of an SMS mail is selected according to this display is described with reference to flowcharts shown in FIG. 14 and FIG. 15. Here, the processor 12 executes the processing shown in FIG. 14 and FIG. 15 according to the program stored in the ROM 16. In the following description, one address book file 50 is called a “record”, and each item stored in the address book file 50 is called an “item”. Furthermore, each record is constructed of a page for each line (“A column of Japanese Kana syllabary” and “Ka column of Japanese Kana syllabary”, etc.) to which an initial character of reading of a name of each registered individual (50b (see FIG. 6)), etc. belongs. Furthermore, the records shall be sorted according to the Japanese Kana syllabary of the reading within the page.

First, the processor 12 determines whether or not an operation of selecting a destination of an SMS mail is performed by the user in a step S1 shown in FIG. 14. The operation of selecting a destination is an operation of selecting the “address book call” on the display state of the LCD monitor 24 shown in FIG. 9. When it is determined that an operation of selecting a destination is selected in the step S1 (step S1:YES), the processor 12 points at the initial page of the address book 42, that is, the initial record on the page of “A column of Japanese Kana syllabary” with a pointer P1 in a step S3. In the example shown in FIG. 5, the record recording the information on [symbol] (Japanese Kanji (AOSHIMA Syunsaku)) is pointed out.

Next, in a step S5, it is determined whether or not there is an item registering a phone number about which the kind of carrier is the “B company” being the carrier which offers a service to this mobile phone apparatus 10 in the record currently pointed. More specifically, each item of the record currently pointed is searched, and it is determined whether or not there is an item storing the kind of carrier the same as the kind of carrier (B company) stored in the kind of carrier 40c of the profile information 40 (see FIG. 3) being the information of the owner of the mobile phone apparatus 10.

If it is determined that there is an item storing the same kind of carrier, (step S5:YES) in the step S5, the record is copied in the RAM 14, and on the basis of the record copied in the RAM 14, the name stored in the item of the name of this record (50a (see FIG. 6)) is displayed on the LCD monitor 24 in a step S7. On the other hand, if it is determined that there is no item storing the same kind of carrier (step S5:NO), the step S7 is skipped.

Then, in a step S9, it is determined whether or not the record currently pointed is the last record on this page. If it is determined that this is not the last record (step S9:NO), a next record on this page is pointed out in a step S11, and the process returns to the step S5. Accordingly, a display of a name stored in the item of a name 50a of the record about which the kind of carrier is the same as that of this mobile phone apparatus 10 is repeated until the last record of this page in the step 7. As a result, a list of the names of the communication partners to which an SMS mail can be sent is displayed on the LCD monitor 24 as shown in FIG. 10.

On the other hand, if it is determined that this is the last record (step S9:YES), it is determined whether or not a forward operation is performed in a step S13.

Here, the forward operation is an operation of forwardly proceeding the page on which a record is pointed, and corresponds to an operation of performing a key input on the right direction key 20d to move the cursor C1 from the position of the “A column of Japanese Kana syllabary” to the position of the “Ka column of Japanese Kana syllabary” of the displayed line selecting field 60 in the displayed state of the LCD monitor 24 as shown in FIG. 10. When it is determined that an forward operation is performed in the step S13 (step S13:YES), an initial record on a page following to the page to which the record currently pointed belongs is pointed in a step S15, and the process returns to the step S5. At this time, the records on the older page stored in the RAM 14 are all cleared.

On the other hand, if it is determined that an forward operation is not performed in the step S13 (step S13:NO), it is determined that a backward operation is performed in a step S17. Here, the backward operation is an operation of backwardly proceeding the page on which a record is pointed, and corresponds to an operation of performing a key input on the left direction key 20d to move the cursor Cl from the position of the “A column of Japanese Kana syllabary” to the position of the “A (alphabet)” of the displayed line selecting field 60 in the displayed state of the LCD monitor 24 as shown in FIG. 10.

When it is determined that a backward operation is performed in the step S17 (step S17:YES), an initial record on a page previous to the page to which the record currently pointed belongs is pointed out in a step S19, and the process returns to the step S5. At this time, the records on the older page stored in the RAM 14 are all cleared. Here, the pages of the address book 42 are cyclically constructed, and the page directly after the initial page (page of “A column of Japanese Kana syllabary”) becomes the last page (page of “A” (alphabet)). On the other hand, when it is determined backward operation is not performed in the step S17 (step S17:NO), it is determined whether or not selection of a record is performed in a next step S21.

Here, the selection of the record corresponds to an operation of selecting the [symbol] (Japanese Kanji (ONONO Komachi)) (identification information of the registrant) by designating the “select” at the center portion of the bottom field UC in a state that the cursor C2 is placed at [symbol] (Japanese Kanji (ONONO Komachi)) while the LCD monitor 24 shown in FIG. 10 is displayed.

When it is determined that a record is not selected in the step S21 (step S19:NO), the process returns to the step S13. On the other hand, when it is determined that a record is selected (step S21:YES), in the selected record, that is, in the record currently pointed by the pointer P1, a first item in which a phone number is stored is pointed by the pointer P2 in a step S23 in FIG. 15.

Then, in a step S25, it is determined whether or not the kind of carrier of the phone number currently pointed is the same as the carrier which offers a service to this mobile phone apparatus 10. More specifically, it is determined whether or not the kind of carrier of the item stored in the record by being brought into correspondence with the phone number of the item currently pointed is the same as the kind of carrier (B company) stored in the kind of carrier 40c of the profile information 40 (see FIG. 3) being the information of the owner of this mobile phone apparatus 10.

If it is determined that the kind of carriers are the same in the step S25 (step S25:YES), the phone number stored in the item currently pointed is displayed on the LCD monitor 24 in a step S27. On the other hand, if it is determined that the kind of carriers are not the same (step S25:NO), the step S27 is skipped, and the process proceeds to a step S29.

In the step S29, it is determined whether or not the item currently pointed is the last item storing the phone number. If it is determined that this is not the last item (step S29:NO), a next item storing the phone number is pointed out in a step S31, and the process returns to the step S25. On the other hand, if it is determined that this is the last item storing the phone number (step S29:YES), it is determined whether or not selection of a phone number is performed in a step S33. Here, the selection of the phone number corresponds to an operation of designating the “select” at the center portion of the bottom field UC in a state that the cursor C5 is placed at any one of the displayed phone numbers in the displayed state of the LCD monitor 24 as shown in FIG. 11. Then, when it is determined that a phone number is selected in the step S33 (step S33:YES), the selected phone number is set as a destination of an SMS mail in a step S35, and the routine of displaying the address book 42 and selecting a destination is ended.

As described above, in a case that a phone number of a destination of an SMS mail is designated by calling the address book 42, only the name and the phone number of the registrant capable of sending an SMS mail are displayed on the basis of the kind of carrier stored in the item (item) included in the address book file 50 (record).

However, not displaying only the name of the registrant capable of sending an SMS mail as described above, but displaying the name of the registrant capable of sending an SMS mail in such a manner as to differentiate it from the names of other registrants may be performed. For example, as shown in FIG. 27, the names of the registrants incapable of sending an SMS mail, such as “Agatha Christie”, [symbol] [symbol] (Japanese Kanji (ANDOU Hiroshige)) and [symbol] (Japanese Kanji OKAMOTO Taro)) can be differentiated by being displayed in color lighter than that of the names of the registrants capable of sending an SMS mail [symbol] (Japanese Kanji (AOSHIMA Syunsaku)), [symbol] (Japanese Kanji (OKITA Souji)), and [symbol] [symbol] (Japanese Kanji (ONONO Komachi))). Here, in FIG. 27, due to reasons of expression, parts to be displayed in a light color are shown as half-tone dot meshing. In this case, when the cursor C2 is moved downward, “Agatha Christie”, [symbol] (Japanese Kanji (ANDOU Hiroshige)), and [symbol] (Japanese Kanji OKAMOTO Taro)) displayed in lighter color may be skipped such that the cursor C2 is not placed. Alternatively, the cursor C2 is placed at the names displayed in the light color, but a designation of the “select” at the center portion of the bottom field UC may not be accepted. Still alternatively, a designation of the “select” at the center portion of the bottom field UC is accepted, but in a case that the “select” is designated, a message showing that this destination cannot be designated as a destination of an SMS mail may be displayed on the LCD monitor 24.

Next, processing of registering such a kind of carrier in the address book 42 is described. First, in order to register the kind of carrier in the address book 42, the kind of carrier of the phone number of the communication partner registered in the address book 42 has to be known. Then, as a method of knowing the kind of carrier, a method of directly inquire it of the communication partner, a method of judging from a domain name of the e-mail address assigned to the mobile phone apparatus of the phone number of the communication partner, and a method of judging from an answer tone when a phone call is made are conceivable.

The aforementioned second method of judging from a domain name of the e-mail address is effective when a communication partner changes the carrier by using the number portability system, and only an message showing that the e-mail address is changed is sent from this communication partner by e-mail.

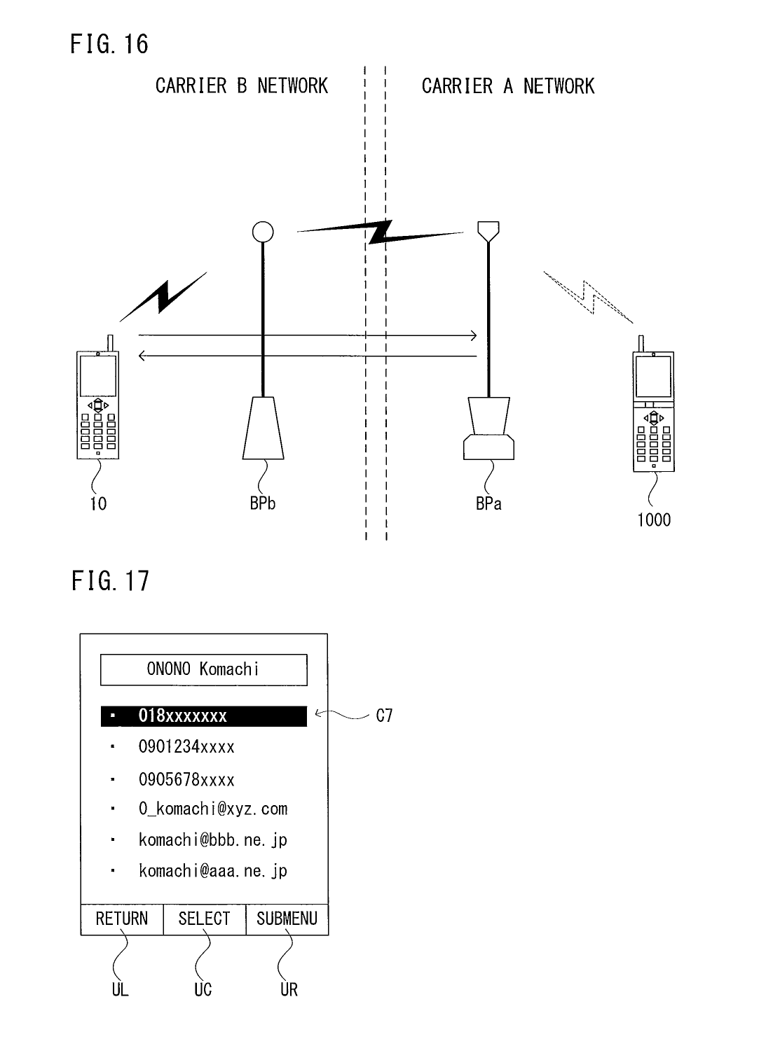

The aforementioned third method of judging from an answer tone when a phone call is made is based on a fact that in a case that a calling is performed from the mobile phone apparatus 10 which obtains a service from the carrier B company to a mobile phone apparatus 1000 which obtains a service from a predetermined carrier (A company in FIG. 16 example) as shown in FIG. 16, from a base station BPa of a carrier A network of the A company, a tone specific to the carrier is sent to the mobile phone apparatus 10 being the source of calling via a carrier B network of the B company.

The answer tone is “ppp” in a case of au (KDDI), “pupupu” in a case of SoftBank, and “silent” in a case of Docomo (NTT). Thus, depending on the difference of the answer tones, it is possible to identify the carrier. Here, the identification of the carrier based on the answer tone may be determined by the processor 12 on the basis of the presence or absence, or the contents of the data (signal) of the answer tone sent from the mobile phone apparatus 1000 (base station BPa) of the communication partner at a time of a communication. In this case, the user selects the phone number registered in the address book 42, and registers in the address book 42 the information indicating the kind of the carrier judged by the processor 12 by bringing it into correspondence with the selected phone number.

The kind of carrier that is known or obtained by such methods can be stored in the address book 42 by being brought into correspondence with the phone number in the following manner. That is, while a key input is performed on the address book key 20g to open the address book 42 as shown in FIG. 5, when a key input is performed on the down key 20b to thereby place the cursor C2 at the [symbol] [symbol] (Japanese Kanji (ONONO Komachi)), for example, and a key input is performed on the function key 20e to designate the “select” at the center portion of the bottom field UC, the registration information of the [symbol] (Japanese Kanji (ONONO Komachi)) as shown in FIG. 17 is displayed. As understood from FIG. 17, in the address book 42, only three phone numbers, such as “018xxxxxxx”, “901234xxxx”, and “0905678xxxx” with respect to [symbol] (Japanese Kanji (ONONO Komachi)) are registered.

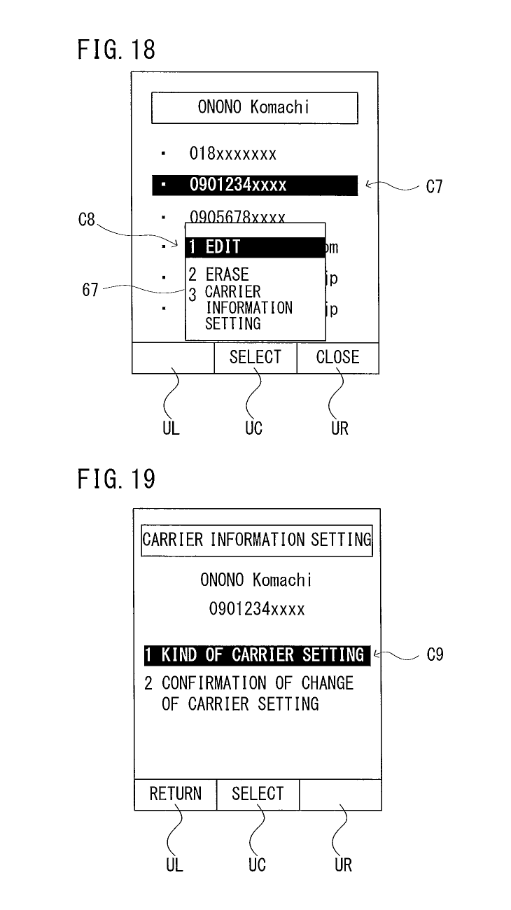

While the registered phone numbers are displayed as shown in FIG. 17, when a key input is performed on the down key 20b to place the cursor C7 at the “0901234xxxx”, for example, and a key input is performed on the function key 20g to designate a “submenu” at the right portion of the bottom field UR, a submenu display rectangle 67 as to the phone number “0901234xxxx” as shown in FIG. 18 is displayed. In the submenu display rectangle 67, “edit”, “erase”, and “carrier information setting” are displayed as a menu. The “edit” is selected to edit the content of the phone number “0901234xxxx”, and the “erase” is selected to erase the phone number “0901234xxxx” from the address book file 50. Then, when the “carrier information setting” is selected, that is, when a key input is performed on the function key 20e to designate the “select” at the center portion of the bottom field UC in a state that a key input is performed on the down key 20b to place the cursor C8 at the “carrier information setting”, a setting menu as to the carrier information as shown in FIG. 19 is displayed on the LCD monitor 24.

As shown in FIG. 19, “setting of the kind of carrier” and “setting of confirmation of a change of carrier” are displayed on the LCD monitor 24 as a setting menu of the carrier information. The menu of the “setting of the kind of carrier” is a menu for setting (registering) the kind of the carrier corresponding to this phone number, that is, the “0901234xxxx” selected by the cursor C7 in FIG. 18 and displayed in FIG. 19. Furthermore, the menu of the “setting of confirmation of a change of carrier” is a menu for setting whether to prompt the user of the mobile phone apparatus 10 to periodically confirm whether or not there is a change in the kind of carrier of the phone number of the registrant after the kind of carrier corresponding to the phone number is set (registered). It is determined whether or not a predetermined period has elapsed since the kind of the carrier is confirmed last after the user of the mobile phone apparatus 10 makes a phone call to this phone number and ends the speech communication or since the kind of the carrier is changed, and prompting the user to confirm whether there is a change in this kind of carrier is performed if the predetermined period has elapsed.

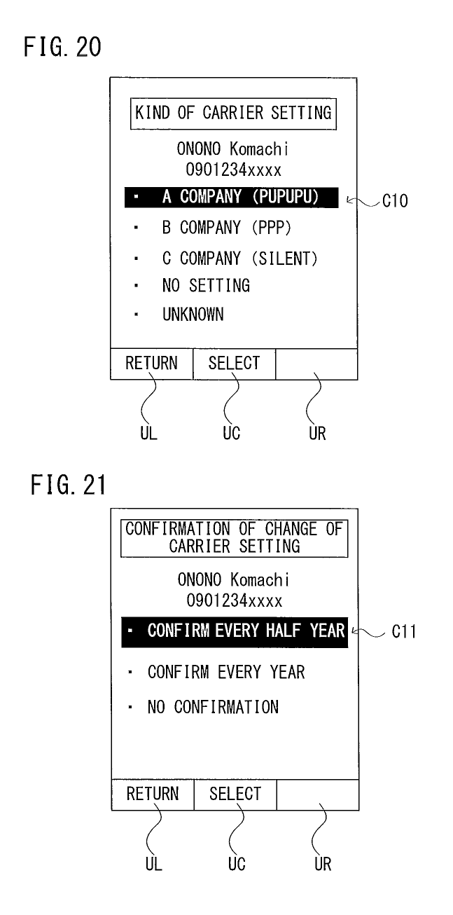

When the “select” at the center portion of the bottom field UC is designated in a state that the cursor C9 is placed at the “setting of the kind of carrier” as shown in FIG. 19, a screen as shown in FIG. 20 for setting (registering) the kind of carrier is displayed on the LCD monitor 24. As shown in FIG. 20, as options of setting the kind of carrier, “A company”, “B company”, “C company”, “unknown”, and “no setting” are provided. When each of the options, such as the “A company”, the “B company”, and the “C company” is selected, that is, when the “select” at the center portion of the bottom field UC is designated in a state that a cursor C10 is placed at any one of the “A company”, the “B company”, and the “C company”, it is possible to set any one of the A company, the B company, and the C company as a carrier. When the kind of carrier is thus set, the item of the kind of carrier (2) 50g storing the kind of carrier by bringing it into correspondence with the item of the phone number (2) 50f and the last confirmation of the change of the carrier (2) 50h storing that day when the kind of carrier is set are added to the address book file 50 (see FIG. 6) of the [symbol] (Japanese Kanji (ONONO Komachi)) as shown in FIG. 6. Here, the information on that day when the kind of carrier is set is acquired from the time counting circuit 30.

In FIG. 20 example, the phone number is “0901234xxxx” being a phone number of the mobile phone apparatus, but in a case that the target phone number is a phone number of a land-line phone such as “018xxxxxxx”, etc., “no setting” is selected so as not to register the kind of carrier. Thereupon, in the address book file 50, the item of the kind of carrier (1) 50d storing “no setting” is added. In this case, the item storing that day when the kind of carrier is set (last confirmation of a change of a carrier kind (1)) is not added.

Furthermore, in a case that the phone number is a phone number of the mobile phone apparatus, but the carrier is unknown, the “unknown” is selected. Thereupon, in the address book file 50, the kind of carrier (3) 50k storing the “unknown” and the last confirmation of the change of the carrier (3) 50m storing the day when the kind of carrier is set (when the “unknown” is set in this case) are added.

On the other hand, when the “setting of confirmation of a change of carrier” is selected in a state that the LCD monitor 24 is displayed as shown in FIG. 19, a screen for setting a confirmation of a change of the kind of carrier is displayed on the LCD monitor 24. As shown in FIG. 21, on the screen for setting a confirmation of a change of the kind of carrier, options, such as “confirmation of a change every half year”, “confirmation of a change every year”, and “no confirmation of a change” are displayed. When the “confirmation of a change every half year” is selected, the item of the confirmation of the change of the carrier (2) 50i storing the text information of “every half year” is added to the address book file 50 by being brought into correspondence with the item of the phone number (2) 50f storing the phone number.

Furthermore, when the “confirmation of a change every year” is selected, in the item of the confirmation of the change of the carrier (2) 50i in the address book file 50, “every year” is stored, and when the “no confirmation of a change” is selected, information of “no confirmation” is stored in the item of the confirmation of the change of the carrier (2) 50i. Here, if the phone number is a phone number of the land-line phone, such as the “018xxxxxxx” stored in the item of the phone number (1) 50c of the address book file 50, and the “no setting” for not setting the kind of carrier is selected on the kind of carrier setting screen in FIG. 20, the item storing the information of the “no confirmation” like the confirmation of the change of the carrier (1) 50e in the address book file 50 is automatically added by the processor 12 of the mobile phone apparatus 10.

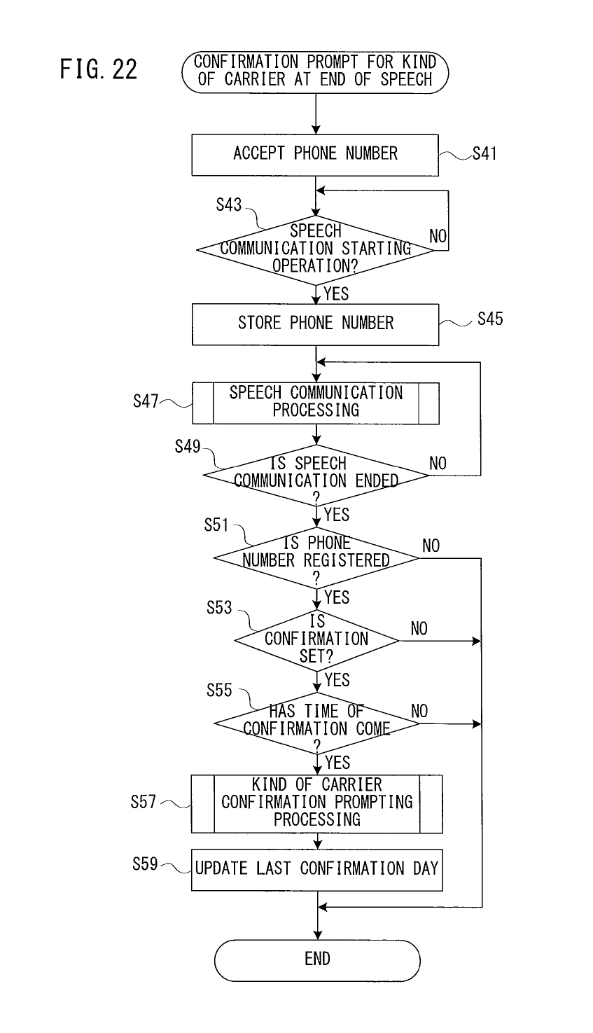

Next, processing of a routine to be executed by the processor 12 of the mobile phone apparatus 10 in a case that the user makes a phone call to a communication partner of a predetermined phone number by utilizing the mobile phone apparatus 10 and ends the speech communication, and the user is then prompted to confirm a change of the kind of carrier of the phone number is described by utilizing FIG. 22. Here, the processor 12 executes the processing shown in FIG. 22 on the basis of the predetermined program stored in the ROM 16.

First, the processor 12 accepts a designation of the phone number of the communication partner with which a phone call is made in a step S41. The designation of the phone number may be a designation by a key input of each key by the numeric keypad 20T, and a designation of a phone number based on the address book 42.

Next, the processor 12 determines whether or not a speech communication starting operation is performed by the user in a step S43. When it is determined that a speech communication starting operation is performed (step S43:YES), the phone number accepted in the preceding step S41 is stored in the RAM 14 as a phone number of the communication partner with which a phone call is made in a step S45. Then, in a step S47, speech communication processing is executed. The speech communication processing in the step S47 is continued until it is determined that the speech communication is ended in a step S49.

When it is determined that the speech communication is ended in the step S49 (step S49:YES), the processor 12 searches the phone number of the communication partner with which a speech communication is made in each address book file 50 of the RAM 14, and determines whether or not the phone number is registered in the address book 42 in a step S51. When it is determined that the phone number stored in the RAM 14 is not registered in the address book 42 (step S51:NO), the routine is ended.

On the other hand, when it is determined that the phone number is registered in the address book 42, with reference to the items storing whether or not the change of the carrier is to be confirmed (items of the confirmation of the change of the carrier(1) 50e, (2) 50i, and (3) 50n in FIG. 6, for example) provided by being brought into correspondence with the items of the address book file 50 (items of the kind of carrier (1) 50c, (2) 50f, and (3) 50j in FIG. 6, for example) storing the phone number the same as that stored in the RAM 14, it is determined whether or not a confirmation of the change of the kind of carrier is set with respect to this phone number in a next step S53. That is, it is determined whether or not information indicating “every half year” or “every year” is stored in each of the items of the confirmation of the change of the carrier (1) 50e, (2) 50i, and (3) 50n.

When it is determined that a confirmation of the change of the kind of carrier is not set (step S53:NO) in the step S53, the routine is ended. On the other hand, when it is determined that a confirmation of the change of the kind of carrier is set (step S53:YES), the processor 12 then determines whether or not a time of confirming the change of the kind of carrier has come with reference to the data from the time counting circuit 30 in a step S55.

That is, the processor 12 acquires the information indicating the current day from the time counting circuit 30, and determines whether or not a time of confirming the change of the kind of carrier has come on the basis of this information, the content of the item storing whether or not the change of the carrier is to be confirmed (items of the confirmation of the change of the carrier(2)50i, and (3) 50n in FIG. 6, for example) provided by being brought into correspondence with the item of the address book file 50 storing a phone number the same as that stored in the RAM 14 (items of the kind of carrier (2) 50f and (3) 50j in FIG. 6, for example) and the content of the item storing the day when the change (registration) of the kind of carrier is performed last (items of the last confirmation of the change of the carrier (2) 50h and (3) 50m in FIG. 6, for example).

More specifically, taking the last confirmation of the change of the carrier (2) 50h and the confirmation of the change of the carrier (2) 50i that correspond to the phone number (1) 50f of the address book file 50 shown in FIG. 6 as examples, it is determined whether or not the current day acquired from the time counting circuit 30 is “half year” indicated by the “every half year” stored in the confirmation of the change of the carrier (2) 50i after “2007 year 4 month 1 day (2007/4/1)” stored in the last confirmation of the change of the carrier (2) 50h.

In the step S55, when it is determined that the time of confirming the change of the kind of carrier has not come, this routine is ended. On the other hand, when it is determined that the time has come, processing of prompting the user to confirm the kind of carrier is executed in a step S57. More specifically, while a sound prompting the user to confirm the kind of carrier is output from the speaker 28, a vibrator (not shown) is operated to thereby draw the user's attention, and then, a screen for performing setting of the kind of carrier is displayed on the LCD monitor 24 as shown in FIG. 20.

Then, in a step S59, the item storing the date when a change (registration) of the kind of carrier is performed last (items of the last confirmation of the change of the carrier (2) 50h and (3) 50m in FIG. 6, for example) provided by being brought into correspondence with the item of the address book file 50 (items of the kind of carrier (2) 50f and (3) 50j in FIG. 6, for example) storing a phone number the same as the phone number stored in the RAM 14 is lastly updated by the current day acquired from the time counting circuit 30, and the routine is ended.

When the speech communication is thus ended, the user is prompted to confirm the kind of carrier of the phone number in relation to this speech communication. The user of the mobile phone apparatus 10 performs the determination of the kind of carrier on the basis of the answer tone returned from the base station BPa (see FIG. 16) of the carrier of the mobile phone apparatus of the communication partner after calling and before the speech communication. Accordingly, after the processor 12 accepts the phone number of the communication partner, and before it performs a calling operation, the processor 12 confirms whether or not a time to confirm the kind of carrier has come, and if the time has come, the user may be informed of an attention to the answer tone for confirmation of the kind of carrier.

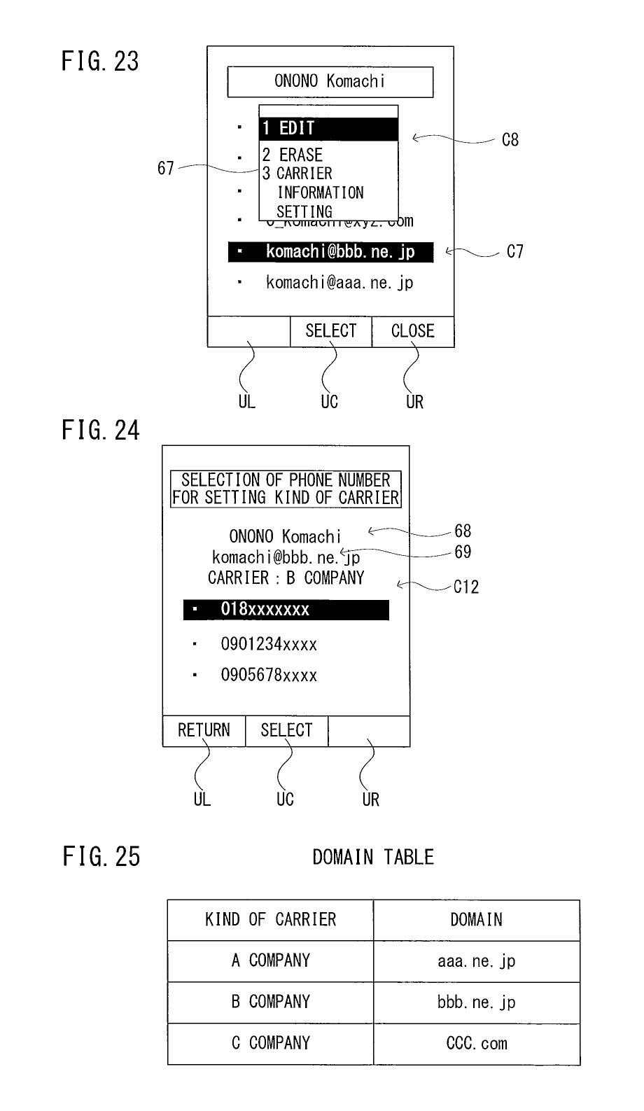

Additionally, the setting of the kind of carrier can also be set on the basis of the mail address of the e-mail registered in the address book 42. For example, as shown in FIG. 17, while the address book 42 is opened to display the information registered as to the [symbol] (Japanese Kanji (ONONO Komachi)), that is, the phone number and the e-mail address, when the “select” at the center portion of the bottom field UC is designated in a state that a key input is performed on the down key 20b to place the cursor C7 at “komachi@bbb.ne.jp”, the submenu display rectangle 67 as to the mail address “komachi@bbb.ne.jp” as shown in FIG. 23 is displayed, jus as the “select” is designated in a state the cursor C7 is placed at the phone number “0901234xxxx” as shown in FIG. 18.

In the submenu display rectangle 67, as described above, menus such as the “edit”, the “erase”, and the “carrier information setting” are displayed. Then, while the submenu display rectangle 67 is displayed on the LCD monitor 24, when the “select” at the center portion of the bottom field UC is designated in a state that a key input is performed on the down key 20b to place the cursor C8 at the “carrier information setting”, a screen for selecting a phone number to set the kind of carrier as shown in FIG. 24 is displayed.

As shown in FIG. 24, on the screen for selecting a phone number to set the kind of carrier, an e-mail address displaying field 68 and a kind of carrier displaying field 69 are provided, and below these fields, a list of phone number registered as to the [symbol] (Japanese Kanji (ONONO Komachi)) is selectably displayed. The e-mail address displayed in the e-mail address displaying field 68 is an e-mail address selected by the cursor C7 in FIG. 23.

Then, the kind of carrier displayed in the kind of carrier displaying field is the kind of the carrier which is identified on the basis of the domain of the e-mail address displayed in the e-mail address displaying field 68 and offers a service to this e-mail address. As described before, in the flash memory 18, the domain table 44 as shown in FIG. 25 is stored. The domain table 44 is a table in which the domains of the e-mail addresses and the kinds of carrier are stored by being brought into correspondence with each other as illustrated. The processor 12 searches the domain of the e-mail address displayed in the e-mail address displaying field 68 in the domain table 44, to thereby specify the kind of carrier corresponding to the e-mail address. The kind of carrier is thus specified, and therefore, the domain stored in the domain table 44 plays a role in the “carrier information”. Then, the kind of carrier thus specified is displayed in the kind of carrier displaying field 69.

The user selects the phone number corresponding to the e-mail address displayed in the e-mail address displaying field 68, that is, the phone number belonging to the mobile phone apparatus to which this e-mail address is assigned with reference to the display of the LCD monitor 24 shown in FIG. 24. The kind of carrier of the phone number corresponding to the e-mail address displayed in the e-mail address displaying field 68 is equivalent to the kind of carrier of this e-mail address, and therefore, the user can set the kind of carrier of the phone number by selecting the phone number by operating the cursor C12 from the list of the phone number shown in FIG. 24.

When the phone number is thus selected, the item of the kind of carrier (2) 50g storing the “B company” as a kind of carrier corresponding to the item of the phone number (2) 50f storing the “0901234xxxx” in the example shown in FIG. 24 is added to the address book file 50 of the [symbol] (Japanese Kanji (ONONO Komachi)). Here, the item of the last confirmation of the change of the carrier (2) 50h for storing the day when the carrier is changed (registered) last in which the current day is stored is also added at this time.

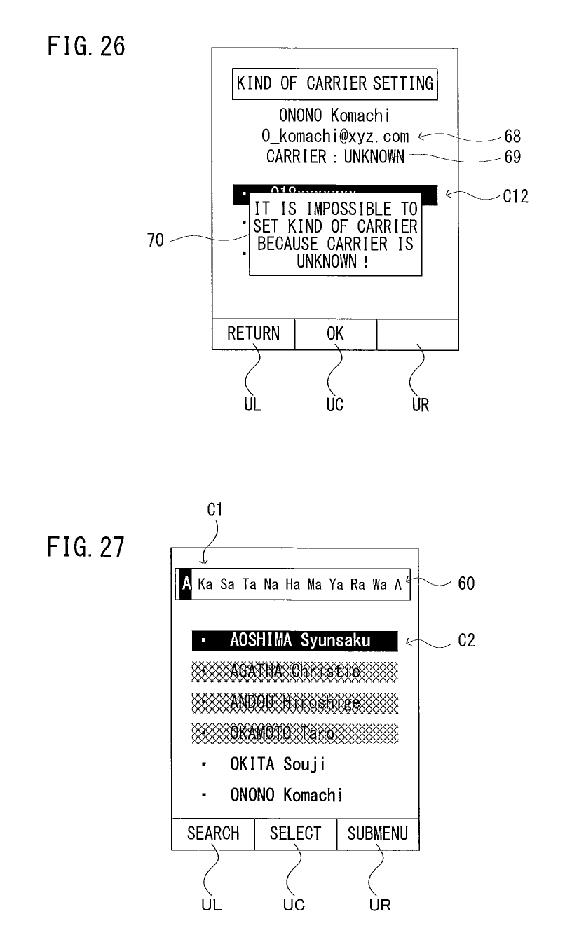

Furthermore, when the e-mail address whose domain is not registered in the domain table 44 unlike o-komachi@xyz.com and which does not belong to the carrier of the mobile phone is selected on the screen displaying the information as to the [symbol] (Japanese Kanji (ONONO Komachi)) shown in FIG. 17, “unknown” indicating that identification of the kind of carrier is impossible is displayed in the kind of carrier displaying field 69, and a message displaying rectangle 70 displaying a message that it is impossible to set the kind of carrier because the carrier is unknown is further displayed as shown in FIG. 26.

As described above, according to the mobile phone apparatus 10 of the present invention, when a phone number of a destination of an SMS mail is selected on the basis of the address book 42, only a name of a registrant of a phone number about which the kind of the carrier is the same as the kind of carrier of this mobile phone apparatus 10 is displayed. In a case that the displayed name of the registrant is further selected, out of the phone numbers registered and owned by this registrant, only the phone number about which the kind of the carrier is the same as the kind of carrier of this mobile phone apparatus 10 is selectably displayed. Accordingly, the user of the mobile phone apparatus 10 can simply and surely select the phone number effective as a destination of an SMS mail.

Additionally, the above-described one is an example of the embodiment of the present invention, and the form of the embodiment can be changed within a scope of the present invention. For example, in the above-described embodiment, in the item of the kind of carrier (2) 50g of the address book file 50 (see FIG. 6), the definite kind of carrier such as the “B company”, etc. is stored, but in place of this configuration, information (carrier information) indicating whether or not this is the same as the kind of carrier of this mobile phone apparatus 10, such as “◯” (in a case that both of them are same) or “×” (in a case that both of them are different) may be stored in the item of the kind of carrier (2) 50g.

Although the present invention has been described and illustrated in detail, it is clearly understood that the same is by way of illustration and example only and is not to be taken by way of limitation, the spirit and scope of the present invention being limited only by the terms of the appended claims

### INDUSTRIAL APPLICABILITY

The present invention can be applied to a mobile phone terminal. More specifically, the present invention can be applied to mobile phone terminals having short message service functions.

### EXPLANATION OF REFERENCE CHARACTERSTERS

10 mobile phone apparatus (mobile phone terminal)
12 processor
14 RAM
16 ROM
18 flash memory
20 key input device
22 LCD driver
24 LCD monitor
26 mic. (microphone)
28 speaker
30 time counting circuit
32 transmitter/receiver circuit
34 antenna
40 profile information
42 address book
44 domain table
50 address book file

1. A mobile phone terminal having a short message service function, comprising:
a first storage which stores an address book in which carrier information of mobile phone terminals of registrants is registered by being brought into correspondence with phone numbers of the mobile phone terminals of the registrants and identification information of the registrants;
a second storage which stores a kind of carrier of an own terminal;
a first displayer which displays on a monitor the identification information of a registrant corresponding to the carrier information indicating that the kind of carrier is the same as the kind of carrier of the own terminal stored in the second storage out of the identification information of the registrants registered in the address book in response to a destination selection starting operation of a mail of a short message service;
a selector which selects the identification information of the registrant in response to a selecting operation based on the display by the first displayer; and
a setter which sets the phone number corresponding to the identification information of the registrant selected by the selector as a destination of the mail of the short message service.

2. A mobile phone terminal having a short message service function, comprising:
a first storage which stores an address book in which carrier information of a mobile phone terminals of registrants is registered by being brought into correspondence with phone numbers of the mobile phone terminals of the registrants and identification information of the registrants;
a second storage which stores a kind of carrier of an own terminal;
a first displayer which displays on the monitor the identification information of a registrant corresponding to the carrier information indicating that the kind of carrier is the same as the kind of carrier of the own terminal stored in the second storage out of the identification information of the registrants registered in the address book such that it can be discriminated from the identification information of the other registrants in response to a destination selection starting operation of a mail of a short message service;
a selector which selects the identification information of the registrant displayed so as to be discriminated from the other registrants in response to a selecting operation based on the display by the first displayer; and
a setter which sets the phone number corresponding to the identification information of the registrant selected by the selector as a destination of a mail of the short message service.

3. A mobile phone terminal according to claim 2, wherein
the setter
comprises a second displayer which displays on the monitor the phone number corresponding to the carrier information indicating that the kind of carrier is the same as the kind of carrier of the own terminal stored in the second storage out of the phone numbers registered in the address book by being brought into correspondence with the identification information of the registrants selected by the selector, and
sets the phone number corresponding to a selecting operation based on the display by the second displayer as a destination of a mail of the short service mail.

4. A mobile phone terminal according to claim 1, further comprising:
a disconnection detector which detects an end of a speech communication;
a determiner which, when the disconnection detector detects an end of a speech communication, determines whether or not a predetermined period has elapsed since the kind of carrier registered in the address book by being brought into correspondence with the phone number in relation to the speech communication was registered in the address book, and
a prompter which prompts a user to confirm the kind of carrier corresponding to the phone number in relation to the speech communication when the determiner determines that a predetermined period has elapsed.

5. A mobile phone terminal according to claim 1, further comprising a register which registers the carrier information of the mobile phone terminal of the registrant by bringing it into correspondence with the phone number of the mobile phone terminal of the registrant and the identification information of the registrant in the address book in response to a registering operation.

6. A mobile phone terminal according to claim 5, wherein the register registers the carrier information based on the kind of carrier determined on the basis of a domain of the e-mail address of the registrant registered in the address book.

7. A mobile phone terminal according to claim 5, wherein the register registers the carrier information based on the kind of carrier determined on the basis of a signal received when a phone call is made with a telephone apparatus of the communication partner.

8. A mobile phone terminal according to claim 2, wherein
the setter
comprises a second displayer which displays on the monitor the phone number corresponding to the carrier information indicating that the kind of carrier is the same as the kind of carrier of the own terminal stored in the second storage out of the phone numbers registered in the address book by being brought into correspondence with the identification information of the registrants selected by the selector, and
sets the phone number corresponding to a selecting operation based on the display by the second displayer as a destination of a mail of the short service mail.

9. A mobile phone terminal according to claim 2, further comprising:
a disconnection detector which detects an end of a speech communication;
a determiner which, when the disconnection detector detects an end of a speech communication, determines whether or not a predetermined period has elapsed since the kind of carrier registered in the address book by being brought into correspondence with the phone number in relation to the speech communication was registered in the address book, and
a prompter which prompts a user to confirm the kind of carrier corresponding to the phone number in relation to the speech communication when the determiner determines that a predetermined period has elapsed.

10. A mobile phone terminal according to claim 2, further comprising a register which registers the carrier information of the mobile phone terminal of the registrant by bringing it into correspondence with the phone number of the mobile phone terminal of the registrant and the identification information of the registrant in the address book in response to a registering operation.

11. A mobile phone terminal according to claim 10, wherein the register registers the carrier information based on the kind of carrier determined on the basis of a domain of the e-mail address of the registrant registered in the address book.

12. A mobile phone terminal according to claim 10, wherein the register registers the carrier information based on the kind of carrier determined on the basis of a signal received when a phone call is made with a telephone apparatus of the communication partner.
